(19) United States
(12) Patent Application Publication
(10) Pub. No.: US 2026/0005963 A1
(43) Pub. Date: Jan. 1, 2026

(54) Prefix Compression To Reduce Overhead Associated with Covering Routes

(71) Applicant: Arista Networks, Inc., Santa Clara, CA (US)

(72) Inventors: Ramakrishnan Ganapathy Iyer, Trivandrum (IN); Vishal Bandekar, Bengaluru (IN)

(21) Appl. No.: 18/756,074

(22) Filed: Jun. 27, 2024

(51) Int. Cl. H04L 45/748; H04L 45/42

(52) U.S. Cl. CPC H04L 45/748; H04L 45/42

(57) ABSTRACT

A network device uses prefix compression to program routes in a forwarding information base (FIB) in a longest prefix match (LPM) table or an exact match (EM) table. The network device compresses routes of a certain prefix length in the FIB into a single entry in the EM table. For a compressed prefix that does not correspond to a route in the FIB (hole), the network device associates the hole with a special value rather than the prefix of a covering route. When the network device receives a packet that matches a hole, the lookup performed on the exact match table results in the special value. In response, the network device uses the result of the lookup performed on the LPM table to determine how to forward the packet.

### CROSS REFERENCE TO RELATED APPLICATIONS

This application is related to:
U.S. Pat. No. 11,522,796, filed Sep. 5, 2019, “Routing Table Selection Based On Utilization;”
U.S. application Ser. No. 17/867,520, filed Jul. 18, 2022, “Prefix Compression Routes In Exact Match Using Redirection And Mirroring FECs In Hardware;”
U.S. Pat. No. 11,818,042, filed Nov. 1, 2022, “Routing Table Selection Based On Utilization;” and
U.S. application Ser. No. 18/161,639, filed Jan. 30, 2023, “Storing and Selection of Entries in Routing Tables Based on Prefix Length,”
   the contents of all of which are incorporated herein by reference in their entirety for all purposes.

### BACKGROUND

A software forwarding information base (FIB) is a routing table in the control plane of a network device that contains forwarding information (e.g., next hop) used to program hardware tables (hardware FIB) in the network device. The hardware FIB is used to facilitate packet forwarding. The hardware FIB comprises a hardware table called a longest prefix match (LPM) table that contains routes from the software FIB. A route comprises a prefix component and a next hop component. The destination address of an incoming packet is matched against one or more prefix components of the routes in the LPM table. The route with the longest matching prefix is selected and the associated next hop is used to forward the packet.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1A is a high level representation of a network device in accordance with the present disclosure.

FIG. 1B is a high level representation of the flow for creating the hardware forwarding information base (FIB).

FIG. 2 is a logical representation of a longest prefix match (LPM) table.

FIGS. 3A and 3B illustrate a logical representation of an exact match (EM) table in accordance with the present disclosure.

FIG. 4 represents a high flow of operations for building up an EM table in accordance with the present disclosure.

FIG. 5 represents a parent-child hierarchy of a /21 prefix.

FIG. 6 is an example of a parent-child hierarchy used to illustrate building up an EM table in accordance with the present disclosure.

FIG. 7 represents a high flow of operations for determining the next hop for a packet in accordance with the present disclosure.

### DETAILED DESCRIPTION

Network devices may employ a prefix compression technique when implementing a forwarding information table (FIB). The network device may compress several routing prefixes into a single forwarding entry and store the single forwarding entry in a hardware table (e.g., an exact match, EM, table). In some instances, a single forwarding entry into which several routing prefixes are compressed can include one or more routing prefixes that do not exist in the FIB; such routes are referred to as holes in the forwarding entry. Holes nonetheless resolve to the prefix of the nearest parent route, referred to as a covering route, which is an ancestor route that is both nearest the hole and in the FIB.

Some network devices can utilize a dual table lookup feature when implementing a FIB. For a dual table lookup feature, a network device can perform lookups on two tables that are each configured to store forwarding entries. For example, in some cases, such a network device may include an exact match (EM) table and a longest prefix match (LPM) table. To determine how to forward a particular packet that the network device receives, the network device can concurrently perform a lookup in the exact match table and a lookup in the LPM table. Based on the results of the lookups, the network device determines a port on the network device through which to forward the particular packet (e.g., a next hop).

The present disclosure is directed to techniques for managing compressed routing information for network devices. These techniques are applicable to network devices that use prefix compression feature and a dual table lookup feature to implement a FIB. In some embodiments, when such a network device generates a single forwarding entry into which several routing prefixes are compressed, the network device may determine that one or more of the several routing prefixes that are compressed into the single forwarding entry are holes in the compressed routing prefixes (i.e., they do not exist in the FIB). For each hole in the compressed routing prefixes, the network device configures the single forwarding entry so that the hole resolves to a special predefined value rather than the next hop of the covering route. The network device stores the single forwarding entry in the exact match table. When the network device receives a packet that matches a hole, the lookup performed on the exact match table would resolve to the special predefined value. In such cases, the network device ignores the result from the exact match table and, instead, uses the result of the lookup performed on the LPM table to determine how to forward the packet.

Employing the techniques described herein provides several benefits and advantages. For instance, when a covering route changes, the network device does not have to check for and update any compressed routing prefix entries in the exact match that have holes covered by the covering route and propagate the changes to such holes. As such, the network device is able to avoid performing the checks and the propagation of the changes in these scenarios. This results in a reduction in the amount of processing and/or resources used to process a change in a covering route. Another benefit of this is the FIB converges faster thereby reducing packet loss or incorrect forwarding.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

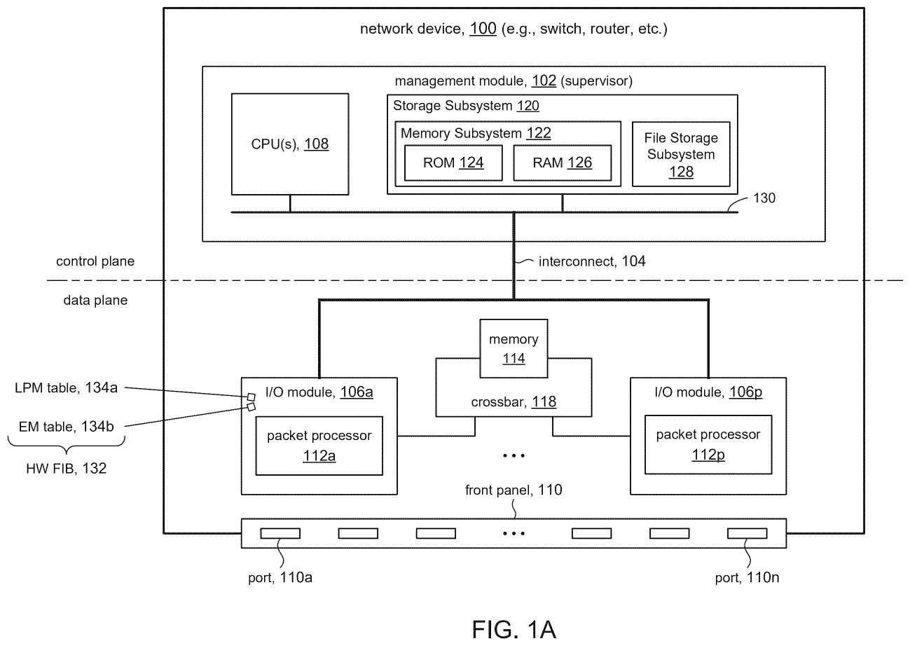

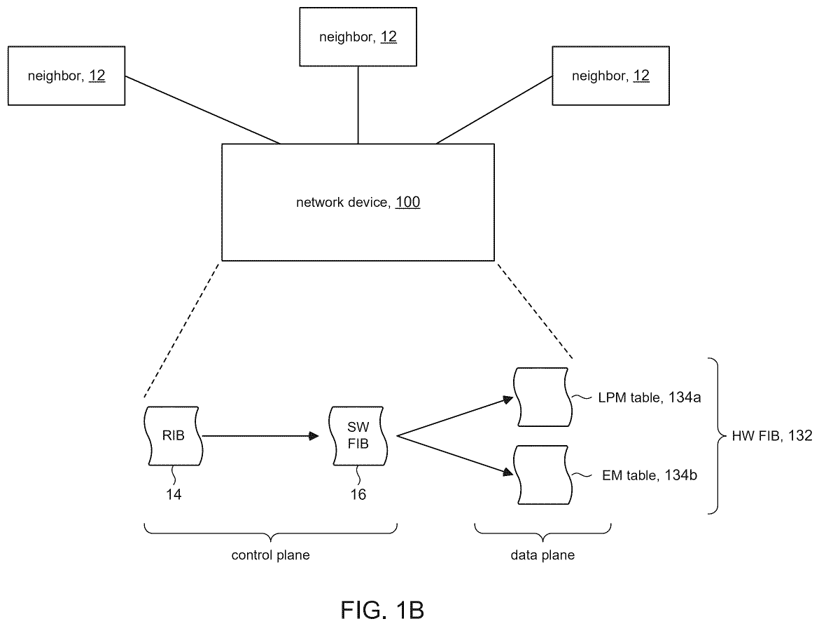

FIG. 1A is a schematic representation of an example network device 100 (e.g., a router, switch, firewall, and the like) that can be adapted in accordance with the present disclosure. In some embodiments, for example, network device 100 can include one or more management modules 102, one or more I/O modules (switches, switch chips) 106a-106p, and a front panel 110 of I/O ports (physical interfaces, I/Fs) 110a-110n. Management module 102 can constitute the control plane of network device 100 (also referred to as the control layer or simply the central processing unit, CPU), and can include CPU(s) 108 for managing and controlling operation of network device 100 in accordance with the present disclosure. CPU(s) 108 can be a general-purpose processor, such as an Intel®/AMD® x86, ARM® microprocessor and the like, that operates under the control of software stored in a memory device/chips such as read-only memory (ROM) 124 or random-access memory (RAM) 126. The control plane provides services that include traffic management functions such as routing, security, load balancing, analysis, and the like.

CPU(s) 108 can communicate with storage subsystem 120 via bus subsystem 130. Other subsystems, such as a network interface subsystem (not shown in FIG. 1A), may be on bus subsystem 130. Storage subsystem 120 can include memory subsystem 122 and file/disk storage subsystem 128. Memory subsystem 122 and file/disk storage subsystem 128 represent examples of non-transitory computer-readable storage devices that can store program code and/or data, which when executed by CPU(s) 108, can cause CPU(s) 108 to perform operations in accordance with embodiments of the present disclosure.

Memory subsystem 122 can include a number of memories such as main RAM 126 (e.g., static RAM, dynamic RAM, etc.) for storage of instructions and data during program execution, and ROM (read-only memory) 124 on which fixed instructions and data can be stored. File storage subsystem 128 can provide persistent (i.e., non-volatile) storage for program and data files, and can include storage technologies such as solid-state drive and/or other types of storage media known in the art.

CPU(s) 108 can run a network operating system stored in storage subsystem 120. A network operating system is a specialized operating system for network device 100. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 130 can provide a mechanism for the various components and subsystems of management module 102 to communicate with each other as intended. Although bus subsystem 130 is shown schematically as a single bus, alternative embodiments of the bus subsystem can utilize multiple buses.

The one or more I/O modules 106a-106p can be collectively referred to as the data plane of network device 100 (also referred to as the data layer, forwarding plane, etc.). Interconnect 104 represents interconnections between modules in the control plane and modules in the data plane. Interconnect 104 can be any suitable bus architecture such as Peripheral Component Interconnect Express (PCIe), System Management Bus (SMBus), Inter-Integrated Circuit (I2C), etc.

I/O modules 106a-106p can include respective packet processing hardware comprising packet processors 112a-112p (collectively 112) to provide packet processing and forwarding capability. Each I/O module 106a-106p can be further configured to communicate over one or more ports 110a-110n on the front panel 110 to receive and forward network traffic. Packet processors 112 can comprise hardware (circuitry), including for example, data processing hardware such as an application specific integrated circuit (ASIC), field programmable gate array (FPGA), processing unit, and the like, which can be configured to operate in accordance with the present disclosure. Each of the packet processors 112 can include forwarding lookup hardware (also referred to as the forwarding information base, FIB, 132) comprising, for example, but not limited to content addressable memory such as ternary CAMs (TCAMs) and auxiliary memory such as static RAM (SRAM). In accordance with the present disclosure, HW FIB 132 can comprise a longest prefix (LPM) table 134a and an exact match (EM) table 134b, details of which are described below.

Memory hardware 114 can include buffers used for queueing packets. I/O modules 106a-106p can access memory hardware 114 via crossbar 118. It is noted that in other embodiments, the memory hardware 114 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

The LPM table 134a comprises routes. A route, in turn, comprises a prefix and a next hop. The prefix refers to prefix notation that represents the leftmost bits of an Internet protocol (IP) address. IPv4 addresses will be used, although it will be appreciated that the present disclosure is applicable to IPv6 addresses.

Prefix notation is understood. Consider the IPv4 address 10.0.10.1, for example, which can be expressed as the following 32-bit value:

$$00001010 \; 00000000 \; 00001010 1.$$

A “/24” (slash 24) prefix refers to the leftmost 24 bits of the IP address. For discussion purposes the leftmost bit will be deemed the most significant bit (MSB); so /24 represents the 24 most significant bits of the IP address. The /24 prefix for the above address 10.0.10.1 (expressed as 10.0.10.1/24) can be expressed as the following 24-bit value:

$$00001010 \; 00000000 1010.$$

Likewise, the /21 prefix for the same address, namely 10.0.10.1/21, can be expressed as the following 21 bits:

$$00001010 \; 00000000 1.$$

FIG. 1B represents a high level flow for creating HW FIB 132. Network device 100 exchanges routes with neighbor devices 12 in the network using routing protocols such as Border Gateway Protocol (BGP), Open Shortest Path First (OSPF), and the like. Network device 100 stores the routing information received from its neighbors 12 in a routing information base (RIB) 14. Network device 100 computes forwarding information from all the received routes and stores the computed forwarding information in a routing table (software FIB) 16 in the control plane. The forwarding information is then programmed in HW FIB 132 in the data plane in accordance with the present disclosure. More specifically, routes in FIB 16 can be stored in LPM table 134a or EM table 134b.

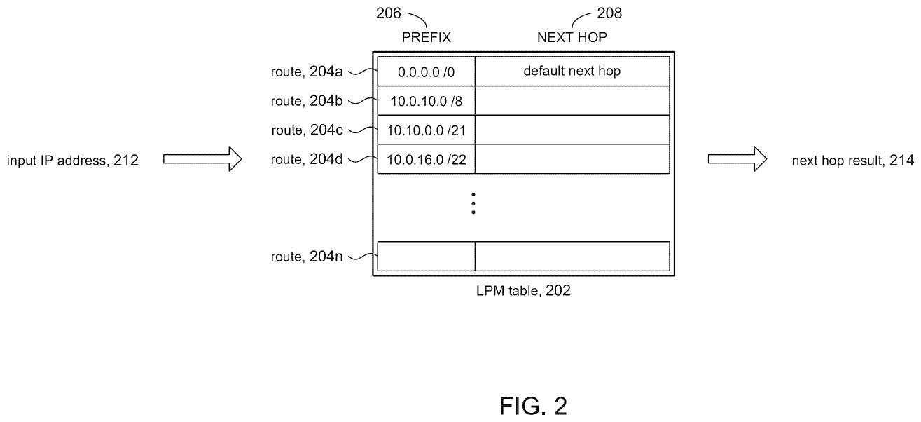

FIG. 2 shows a logical representation of a longest prefix match (LPM) table. An LPM table is understood by persons of ordinary skill in the art. Briefly, LPM table 202 can be a hardware table (e.g., SRAM) that comprises routes 204a, 204b, 204c, 204d, . . . 204n, collectively 204. Each route 204 includes a prefix component 206 and a next hop component 208. An input IP address 212 (e.g., destination IP in an ingress packet) is matched against the routes 206 in LPM table 202. The next hop component 208 corresponding to the matching route that has the longest prefix 206 is output as the next hop result 214. The next hop result 214 contains or provides access to information about the port on the network device on which to transmit the egress packet.

Input IP address 212 is deemed to match a route 204 if that route's prefix matches the corresponding prefix bits in the input IP address. Consider, for example, an input IP address of 10.0.17.1, which can be represented by the following 32 bits:

$$00001010 \; 00000000 \; 00010001 1.$$

It can be seen that this IP address matches on route 204b; the eight prefix bits of route 204b matches the first eight bits (00001010) of the IP address. Likewise, the IP address matches on route 204d; the 22 prefix bits of route 204d matches the first 22 bits (00001010 00000000 000100) of the IP address. The LPM table 202 will output the next hop information contained in or otherwise associated with route 204d because its prefix (22 bits) is longer than the prefix in route 204b (8 bits).

In some embodiments, the LPM table 202 can include a default route 204a whose prefix is 0.0.0.0/0 (prefix length of 0) and functions to match on all input IP addresses so that the LPM table will always output a default next hop as the next hop result 214 if a given input IP address 212 does not match any other route.

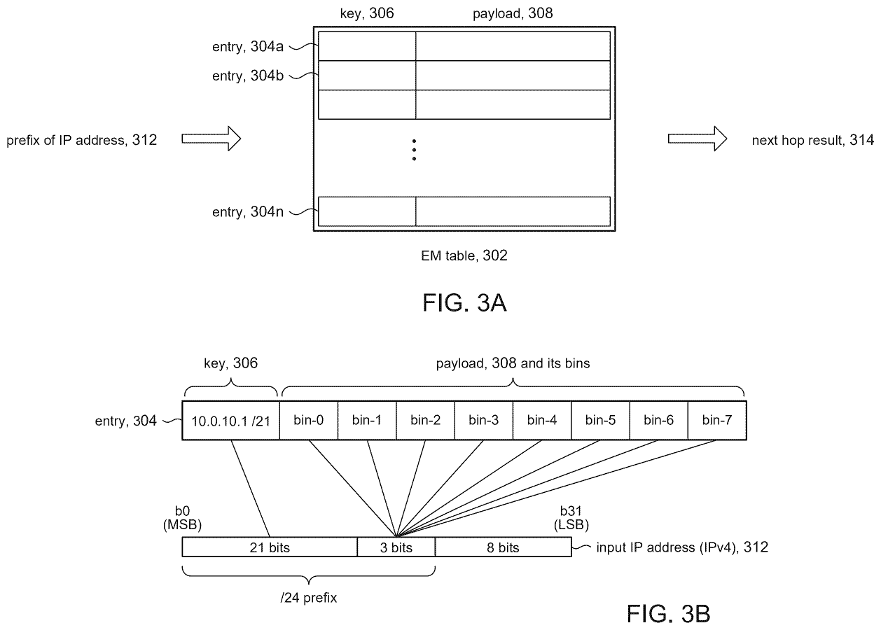

FIGS. 3A and 3B represent an exact match (EM) table in accordance with the present disclosure. In some embodiments, EM table 302 can be a hardware table (e.g., SRAM) organized into entries 304 (304a, 304b, . . . 304n). Each entry is a key-value pair, comprising a “key” component 306 and a “value” component 308 which can be referred to herein as the “payload.”

In accordance with the present disclosure, the EM table 302 stores /24 routes contained in the software FIB (e.g., FIB 16, or simply “FIB”) in compressed form to achieve up to 8-to-1 compression efficiency. The term “/24 route” will be understood to refer to a route that has a /24 prefix.

Referring to FIG. 3B, the key component 306 of EM entry 304 (forwarding entry) contains the /21 parent prefix. The next hops of /24 routes that have the same parent prefix are stored in corresponding bins (locations) in the payload component 308 of EM entry 304, identified in the figure as bin-0 to bin-7. In accordance with the present disclosure, a bin that corresponds to a /24 route that is not in the FIB will contain a special predefined value that is by definition not a valid next hop. The specific special value is implementation specific; for example, in a given implementation, the special value can be ‘0’. It will be appreciated that other embodiments can use different prefix lengths to achieve different compression ratios.

An EM entry 304 is accessed from the EM table 302 by inputting an input IP address 312 (e.g., destination IP in an ingress packet) to the table. An exact match search is performed based on the /21 prefix of the IP address to identify an EM entry 304. The next hop in the payload bin associated with the IP address is output as the next hop result 314. More specifically, and with reference to FIG. 3B:
The network device receives an input IP address (e.g., 312).
An exact-match search of EM table 302 is made using the /21 prefix of the input IP address as the search key. Exact-match means bit-for-bit match between the search key and values in the key component data field 306 of the EM table 302.
A bin in the payload 308 of the matched EM entry 304 is accessed using the last three bits (least significant bits, LSB, b₂₁, b₂₂, b₂₃) in the /24 prefix of the input IP address. For example, bits ‘000’ can access bin-0 in the payload 308, bits ‘001’ can access bin-1 in the payload, bits ‘010’ can access bin-2, and so on.
Output the value contained in the accessed bin; this is the next hop result 314.
   Additional detail is disclosed in the references cited in the above cross-reference section.

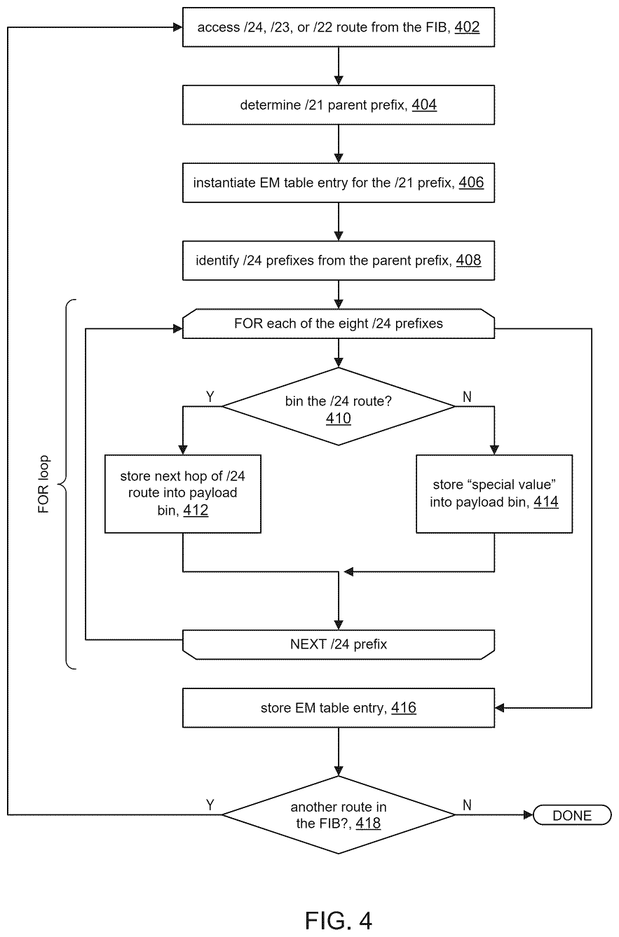

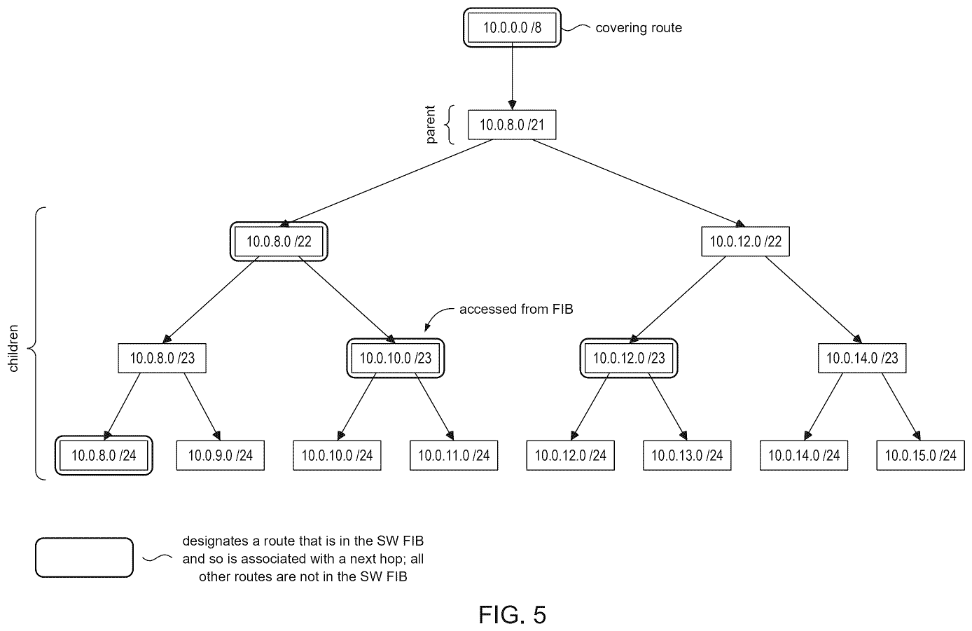

Referring to FIGS. 4 and 5, the discussion will now turn to a high-level description of processing in a network device (e.g., 100, FIG. 1A) to program routes in the software FIB (e.g., FIB 16, FIG. 1B) in accordance with the present disclosure. Depending on a given implementation, the processing may be performed entirely in the control plane or entirely in the data plane, or the processing may be divided between the control plane and the data plane. In some embodiments, the network device can include one or more processing units (circuits), which when operated, can cause the network device to perform processing in accordance with FIG. 4. Processing units (circuits) in the control plane, for example, can include general CPUs that operate by way of executing computer program code stored on a non-volatile computer readable storage medium (e.g., read-only memory); e.g., CPU 108 in the control plane (FIG. 1A) can be a general CPU. Processing units (circuits) in the data plane can include specialized processors such as digital signal processors, field programmable gate arrays, application specific integrated circuits, and the like, that operate by way of executing computer program code or by way of logic circuits being configured for specific operations. For example, each of the packet processors 112a-112p in the data plane (FIG. 1A) can be a specialized processor. The operation and processing blocks described below are not necessarily executed in the order shown. Operations can be combined or broken out into smaller operations in various embodiments. Operations can be allocated for execution among one or more concurrently executing processes and/or threads.

In accordance with some embodiments, routes in the software FIB (“FIB”) that have a prefix length less than 21 can be programmed in the LPM table without compression. For routes that have a prefix length of 21 or greater, operations 402 through 418 can be iterated to program the routes in the EM table (e.g., 302) and not in the LPM table. Each /24, /23, or /22 route in the FIB is processed one at a time as follows:

At operation 402, the network device can access a /24, /23, or /22 route from the FIB for compression. For discussion purposes, the prefix of the accessed route will be referred to as the “precompression” prefix.

At operation 404, the network device can determine the /21 prefix (parent prefix) of the precompression prefix. In some embodiments, the network device can generate a parent-child hierarchy that includes the precompression prefix and the associated /21 parent prefix. Referring to FIG. 5, for example, suppose a route whose prefix is 10.0.10.0/23 is accessed from the FIB. The network device can readily generate the parent-child hierarchy shown in FIG. 5 using the 10.0.10.0/23 prefix. The network device can then traverse the generated parent-child hierarchy to determine that 10.0.8.0/21 is the /21 parent prefix of 10.0.10.0/23. As used herein, the term “parent” refers to an adjacent parent node or an ancestor node.

At operation 406, the network device can instantiate an instance of an EM entry (e.g., 304) to be written into the EM table. The network device can store the /21 parent prefix in the key component data field (e.g., 306) of the EM entry.

At operation 408, the network device can identify the eight /24 prefixes that descend from the /21 parent prefix of the precompression prefix using the parent-child hierarchy (e.g., FIG. 5) generated at operation 406. Again, supposing that the route 10.0.10.0/23 is accessed from the FIB, then the parent-child hierarchy shown in FIG. 5 can be used to determine the eight /24 prefixes that descend from the 10.0.8.0/21 parent prefix. Having identified the eight /24 prefixes, each /24 prefix can be processed in the following FOR loop comprising operations 410-414:

At decision point 410, a determination is made whether to bin the /24 route. If there is a /24 route in the FIB that corresponds to the /24 prefix being processed (current /24 prefix), then the network device can continue processing at operation 412. In addition, if a parent of the /24 route is a /21, /22 or /23 route that is in the FIB, then the network device also continues processing at operation 412. Otherwise, processing continues at operation 414. Referring to FIG. 5, for example, the 10.0.8.0/24 route would be binned because it is in the FIB. Likewise, the 10.0.9.0/24 route would be binned because its parent route (10.0.8.0/22) is a /22 route that is in the FIB. On the other hand, the 10.0.14.0/24 route would not be binned because its parent route (10.0.0.0/8) is not a /21, /22, or /23 route even though the 10.0.0.0/8 route is in the FIB.

At operation 412, the network device can store (bin) the next hop value associated with the /24 route, or the /21, /22 or /23 parent route, into a bin of the payload component (e.g., 308) of the EM entry. In some embodiments, for example, the payload bin can be identified by the last three bits of the prefix of the /24 route (e.g., FIG. 3B).

At operation 414, the network device can store a special (predefined) value into the payload bin when there is no /24 route in the FIB that corresponds to the current /24 prefix; such a route is referred to as a “hole.” As noted above, the bin can be identified by the last three bits of the current /24 prefix. In accordance with the present disclosure, the special value can be any suitable value that does not represent a valid next hop value. For discussion purposes, the special value can be ‘0’.

Processing can return to the top of the FOR loop to process the next /24 prefix. If all eight of the /24 prefixes have been processed, then processing can continue to operation 416.

At operation 416, the network device can store the EM entry in the EM table. The EM entry is keyed (for searching purposes) with the /21 parent prefix that was determined at operation 404. All eight of the /24 prefixes have been processed. The corresponding bins in the payload portion of the EM entry have been filled in with a next hop value (operation 412) or the special predefined value (operation 414).

At decision point 418, if there are any more /24, /23, or /22 routes in the FIB, then processing can return to operation 402 to process the next such route; otherwise, processing can be deemed complete.

### Alternative to Using the Special Predefined Value

An alternative to storing the special value in the bin of a /24 route that is not in the FIB is to store the next hop of the nearest parent route that is in the FIB. Referring to FIG. 5, consider the 10.0.14.0/24 route for example. This route is not in the FIB and per processing in accordance with the present disclosure as outlined in FIG. 4, the payload bin for the 10.0.14.0/24 route would contain the special value. Alternatively, however, the next hop of the nearest parent route (10.0.0.0/8) can be stored in the bin for the 10.0.14.0/24 route, so the next hop associated with the 10.0.0.0/8 would be stored in the bin for the 10.0.14.0/24 route. This parent route can be referred to as a covering route. Likewise, the covering route for the 10.0.15.0/24 route is also 10.0.0.0/8, and so the bin for the 10.0.15.0/24 route would also include the next hop for the 10.0.0.0/8 route.

During the normal course of managing a network, the next hop of a covering route may get updated. For example, if the next hop for the 10.0.0.0/8 covering route changes, the new next hop for 10.0.0.0/8 would have to be reflected in all the payload bins in the EM table that reference the covering route. If the covering route is deleted from the FIB, then a new covering route would have to be recomputed and all the payload bins in the EM table that reference the old covering route would have to be updated to contain the next hop of the new covering route. It can be appreciated that this can be a significant task on a large deployment.

Employing the techniques described herein provides several benefits and advantages. For instance, when a covering route changes, the network device does not have to check for and make updates to any compressed routing prefix entries in the EM table that have holes covered by the covering route. As such, the network device is able to avoid performing the checks and the propagation of the changes in these scenarios. This results in a reduction in the amount of processing and/or resources used to process a change in a covering route. Another benefit of this is the LPM and EM tables converge faster thereby reducing packet loss or incorrect forwarding.

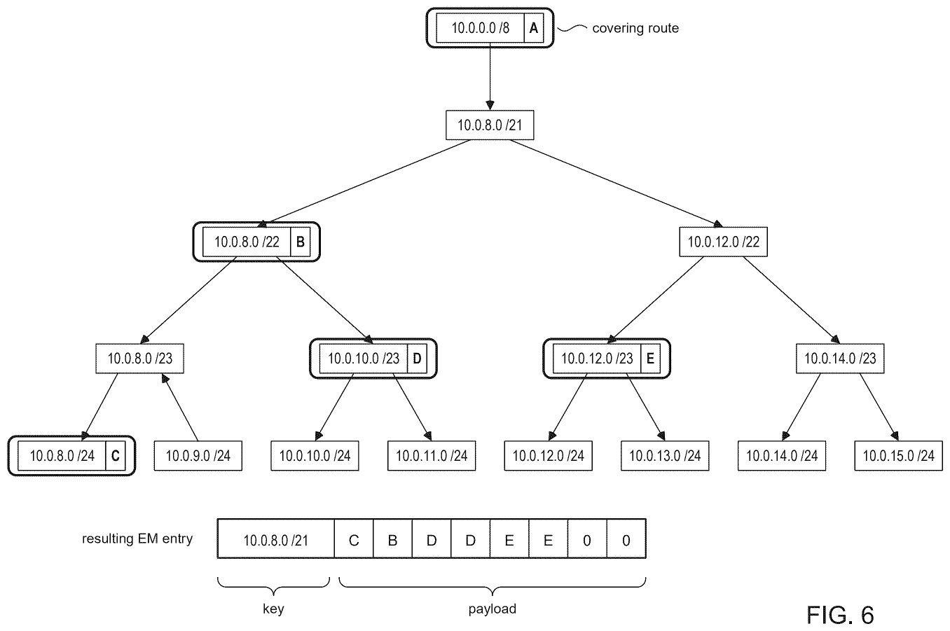

FIG. 6 illustrates the foregoing operations with an example. Suppose the FIB contains the following routes, expressed as prefix, next hop pairs:
10.0.0.0/8, A (next hop)
10.0.8.0/22, B
10.0.10.0/23, D
10.0.12.0/23, E
10.0.8.0/24, C

Suppose the /22 route is selected (operation 402, FIG. 4), namely 10.0.8.0/22. The parent-child hierarchy shown in FIG. 6 can be generated from the 10.0.8.0/22 route (operation 404). The instantiated EM entry initially looks like (operation 406 and FIG. 3B):
key: 10.0.8.0/21, payload: - -, - -, - -, - -, - -, - -, - -, - -
   with all 8 bins initially empty.

Each of the eight /24 prefixes is processed as follows to fill the payload bins in accordance with the FOR loop (operations 410 to 416):
10.0.8.0/24: /24 route IS in FIB, store next hop C in bin 0
10.0.9.0/24: /24 route is NOT in FIB but /22 parent is in FIB, store B in bin 1
10.0.10.0/24: /24 route is NOT in FIB but /23 parent is in FIB, store D in bin 2
10.0.11.0/24: /24 route is NOT in FIB but /23 parent is in FIB, store D in bin 3
10.0.12.0/24: /24 route is NOT in FIB but /23 parent is in FIB, store E in bin 4
10.0.13.0/24: /24 route is NOT in FIB but /23 parent is in FIB, store E in bin 5
10.0.14.0/24: /24 route is NOT in FIB and is covered by /8 parent, store ‘0’ in bin 6
10.0.15.0/24: /24 route is NOT in FIB and is covered by /8 parent, store ‘0’ in bin 7
   After compression, the instantiated EM entry now looks like:
key: 10.0.8.0/21, payload: C, B, D, D, E, E, 0, 0.
   The single EM entry represents up to eight /24 routes in the LPM table. First, the /21 prefix, which is the parent prefix of the eight /24 routes that may be stored in the LPM table, serves as a key to the EM entry. Second, each of the eight bins in the EM entry stores the next hop of a respective /24 route (or its /21, /22, or /23 parent route) if that route was in the software FIB, or the special value (‘0’) if that route was not in the software FIB.

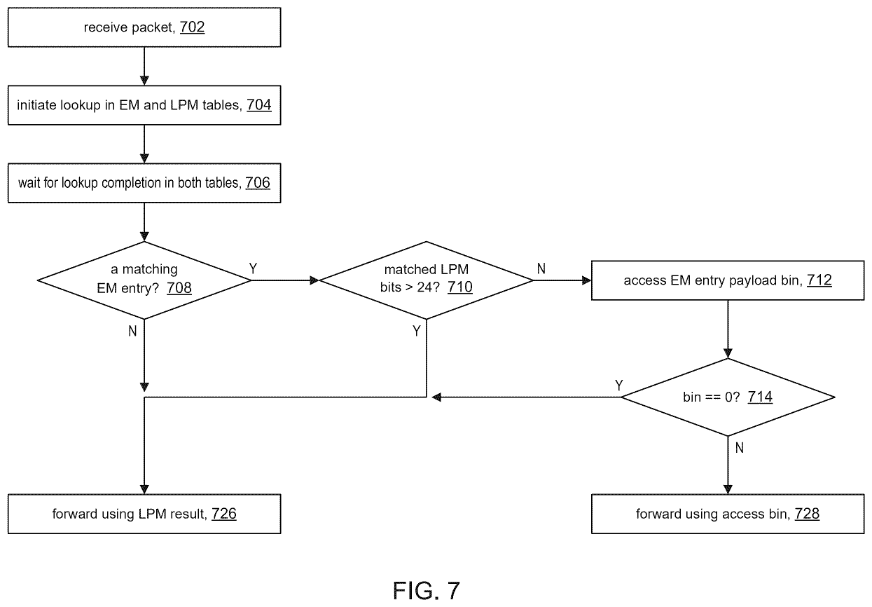

Referring to FIG. 7, the discussion will now turn to a high-level description of processing in a network device (e.g., 100, FIG. 1A) for forwarding a packet using a hardware FIB comprising an LPM table and an EM table in accordance with the present disclosure. The processing may be performed entirely in the data plane, or the processing may be divided between the control plane and the data plane. In some embodiments, the network device can include one or more processing units (circuits), which when operated, can cause the network device to perform processing in accordance with FIG. 7. Processing units (circuits) in the control plane, for example, can include general CPUs that operate by way of executing computer program code stored on a non-volatile computer readable storage medium (e.g., read-only memory); e.g., CPU 108 in the control plane (FIG. 1A) can be a general CPU. Processing units (circuits) in the data plane can include specialized processors such as digital signal processors, field programmable gate arrays, application specific integrated circuits, and the like, that operate by way of executing computer program code or by way of logic circuits being configured for specific operations. For example, each of the packet processors 112a-112p in the data plane (FIG. 1A) can be a specialized processor. The operation and processing blocks described below are not necessarily executed in the order shown. Operations can be combined or broken out into smaller operations in various embodiments. Operations can be allocated for execution among one or more concurrently executing processes and/or threads.

At operation 702, the network device can receive an incoming packet to be processed and forwarded.

At operation 704, the network device can initiate lookup processing concurrently in both the EM table (e.g., 302) and the LPM table (e.g., 202). The destination IP (DIP) address of the incoming packet serves as the input to both the EM table and the LPM table. For discussion purposes, the EM table uses a /21 prefix of the DIP address as the search key. As such, the EM table looks for an exact match of the /21 prefix of the DIP address with EM entries (e.g., 304) in the EM table. More specifically, the EM table looks for an exact match of the /21 prefix with the key components (e.g., 306) of the EM entries. For the LPM table, the LPM table finds the longest prefix that matches the DIP address.

At operation 706, the network device can wait for the lookup operations to complete in both the EM table and LPM table. Upon completion, the EM table will produce a resulting EM entry or not, depending on if an exact match was found. Upon completion, the LPM table will always produce a result, the result will either be (1) the route with the longest prefix that matches the DIP address or (2) a default route with a default prefix (e.g., 0.0.0.0/0) if the DIP did not match on any other prefix in the LPM table.

At decision point 708, if the exact match search of the EM table did not result in an EM entry, that means no next hop is associated with a route that was compressed, and packet forwarding will be based on the next hop from the LPM result (operation 726). If an exact match in the EM table was found (i.e., the search resulted in an EM entry), that means a next hop is associated with a route that was compressed, and forwarding may be based on the next hop from the resulting EM entry.

At decision point 710, if the prefix associated with the LPM result is longer than the /24 prefix associated with the resulting EM entry, that means there is a more specific route in the LPM route than in the resulting EM entry, and so packet forwarding will be based on the next hop from the LPM result (operation 726). If the prefix associated with the LPM result is not longer (shorter) than the /24 prefix associated with the resulting EM entry, that means the resulting EM entry is associated with the more specific route, and so the EM entry is used to forward the packet (operation 712).

At operation 712, the network device can access the payload portion of the resulting EM entry resulting from the exact match search using the DIP address of the incoming packet. More specifically, the three LSB of the /24 prefix of the DIP address can be used to index into the payload to access one of the payload bins (bin-0 to bin-7, FIG. 3B).

At decision point 714, if the accessed bin does not contain a valid next hop value (e.g., special value ‘0’), then packet forwarding will be based on the next hop from the LPM result (operation 726). If the accessed bin contains a valid next hop value, then packet forwarding will be based on the next hop contained in the accessed bin (operation 728).

### Further Examples

Features described above as well as those claimed below may be combined in various ways without departing from the scope hereof. The following examples illustrate some possible, non-limiting combinations:

(A1) A method in a network device for forwarding packets, the method comprising: receiving a packet; concurrently searching both a first table and a second table using the received packet; in response to a search of the second table yielding a search result (table entry): locating a bin in the table entry using the received packet; when the located bin contains a next hop, then forwarding the received packet according to the next hop; and when the located bin contains a predefined value that does not represent a next hop, then forwarding the received packet according a next hop contained in a search result from the first table; and in response to a search of the second table not yielding a search result, forwarding the received packet according to the next hop contained in the search result from the first table.

(A2) The method denoted as (A1), further comprising, in response to both a search of the first table yielding a (first) search result and a search of the second table yielding a (second) search result, forwarding the packet according the first search result or the second search result depending on which search result is associated with a longer prefix.

(A3) The method denoted as any of (A1) through (A2), further comprising using a destination Internet Protocol (DIP) address in the received packet to search the first and second tables.

(A4) For the method denoted as any of (A1) through (A3), wherein searching the second table comprises using a first prefix of a DIP address in the received packet as a lookup key, wherein locating the bin in the table entry comprises using a second prefix of the DIP address.

(A5) For the method denoted as any of (A1) through (A4), wherein the first prefix has a length of 21 bits, wherein the second prefix of the DIP address has a length of 24 bits, wherein locating the bin in the table entry further comprises using the last three bits of the second prefix.

(A6) For the method denoted as any of (A1) through (A5), wherein the first table is a longest prefix match table, wherein the second table is an exact match table.

(B1) A network device comprising: one or more computer processors; and a computer-readable storage device comprising instructions for controlling the one or more computer processors to: receive a packet; concurrently search both a first table and a second table using the received packet; when a search of the second table yields a search result (table entry): locate a bin in the table entry using the received packet; forward the received packet according to the next hop when the located bin contains a next hop; and forward the received packet according a next hop contained in a search result from the first table when the located bin contains a predefined value that does not represent a next hop; and when a search of the second table does not yield a search result, then forward the received packet according to the next hop contained in the search result from the first table.

(B2) For the network device denoted as (B1), wherein the computer-readable storage device further comprises instructions for controlling the one or more computer processors to forward the packet according the first search result or the second search result depending on which search result is associated with a longer prefix when both a search of the first table yielding a (first) search result and a search of the second table yielding a (second) search result.

(B3) For the network device denoted as any of (B1) through (B2), wherein the computer-readable storage device further comprises instructions for controlling the one or more computer processors to use a destination Internet Protocol (DIP) address in the received packet to search the first and second tables.

(B4) For the network device denoted as any of (B1) through (B3), wherein searching the second table comprises using a first prefix of a DIP address in the received packet as a lookup key, wherein locating the bin in the table entry comprises using a second prefix of the DIP address.

(B5) For the network device denoted as any of (B1) through (B4), wherein locating the bin in the table entry further comprises using only a portion of the second prefix of the DIP address.

(B6) For the network device denoted as any of (B1) through (B5), wherein the first table is a longest prefix match table, wherein the second table is an exact match table.

(C1) A method in a network device for compressing routing information, the method comprising the network device: receiving a target prefix associated with a route in a routing table; when the target prefix is less than a predetermined length, then programming the route in a first hardware table; when the target prefix is greater than or equal to the predetermined length, then: identifying a parent prefix of the target prefix; generating children prefixes from the parent prefix; generating a table entry to be written to a second hardware table; storing the parent prefix into a first portion of the generated table entry; for each child prefix among the children prefixes: when the child prefix corresponds to a route in the routing table, then storing a next hop associated with the route into a location in a second portion of the generated table entry that is determined based on the child prefix; and when the child prefix does not correspond to a route in the routing table, then storing a predefined value into the location in the generated table entry that does not represent a next hop; and storing the generated table entry in the second hardware table, wherein storage in the first hardware table is conserved by virtue of representing the routes that correspond to the children prefixes in one entry in the second hardware table and not storing the corresponding routes in individual entries in the first hardware table.

(C2) The method denoted as (C1), further comprising repeating the operations for additional target prefixes received from the routing table.

(C3) For the method denoted as any of (C1) through (C2), wherein the predefined value is used instead of a next hop associated with the parent prefix route when the child prefix is not associated with a route in the routing table.

(C4) For the method denoted as any of (C1) through (C3), wherein the received target prefix is associated with a /24 route or a /23 route or a /22 route in the routing table, wherein one or more of the children prefixes represent/24 routes in the routing table, wherein the parent prefix has length 21.

(C5) For the method denoted as any of (C1) through (C4), wherein the location in the table entry for the compressed routes table is determined based on the last N bits of the child prefix.

(C6) For the method denoted as any of (C1) through (C5), wherein the first hardware table is a longest prefix match hardware (LPM) table and the second hardware table is an exact match (EM) table.

(C7) The method denoted as any of (C1) through (C6), further comprising using the first and second hardware tables to forward a received packet, including searching the first and second hardware tables using the received packet to determine a next hop for the received packet, wherein when the predefined value is encountered in a search result from the second hardware table instead of a next hop, then determining the next hop for the received packet using a search result from the first hardware table.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method in a network device for forwarding packets, the method comprising:
receiving a packet;
concurrently searching both a first table and a second table using the received packet;
in response to a search of the second table yielding a search result (table entry):
locating a bin in the table entry using the received packet;
when the located bin contains a next hop, then forwarding the received packet according to the next hop; and
when the located bin contains a predefined value that does not represent a next hop, then forwarding the received packet according a next hop contained in a search result from the first table; and
in response to a search of the second table not yielding a search result, forwarding the received packet according to the next hop contained in the search result from the first table.

2. The method of claim 1, further comprising, in response to both a search of the first table yielding a (first) search result and a search of the second table yielding a (second) search result, forwarding the packet according the first search result or the second search result depending on which search result is associated with a longer prefix.

3. The method of claim 1, further comprising using a destination Internet Protocol (DIP) address in the received packet to search the first and second tables.

4. The method of claim 1, wherein searching the second table comprises using a first prefix of a DIP address in the received packet as a lookup key, wherein locating the bin in the table entry comprises using a second prefix of the DIP address.

5. The method of claim 4, wherein locating the bin in the table entry further comprises using only a portion of the second prefix of the DIP address.

6. The method of claim 4, wherein the first prefix has a length of 21 bits, wherein the second prefix of the DIP address has a length of 24 bits, wherein locating the bin in the table entry further comprises using the last three bits of the second prefix.

7. The method of claim 1, wherein the first table is a longest prefix match table, wherein the second table is an exact match table.

8. A network device comprising:
one or more computer processors; and
a computer-readable storage device comprising instructions for controlling the one or more computer processors to:
receive a packet;
concurrently search both a first table and a second table using the received packet;
when a search of the second table yields a search result (table entry):
locate a bin in the table entry using the received packet;
forward the received packet according to the next hop when the located bin contains a next hop; and
forward the received packet according a next hop contained in a search result from the first table when the located bin contains a predefined value that does not represent a next hop; and
when a search of the second table does not yield a search result, then forward the received packet according to the next hop contained in the search result from the first table.

9. The network device of claim 8, wherein the computer-readable storage device further comprises instructions for controlling the one or more computer processors to forward the packet according the first search result or the second search result depending on which search result is associated with a longer prefix when both a search of the first table yielding a (first) search result and a search of the second table yielding a (second) search result.

10. The network device of claim 8, wherein the computer-readable storage device further comprises instructions for controlling the one or more computer processors to use a destination Internet Protocol (DIP) address in the received packet to search the first and second tables.

11. The network device of claim 8, wherein searching the second table comprises using a first prefix of a DIP address in the received packet as a lookup key, wherein locating the bin in the table entry comprises using a second prefix of the DIP address.

12. The network device of claim 11, wherein locating the bin in the table entry further comprises using only a portion of the second prefix of the DIP address.

13. The network device of claim 8, wherein the first table is a longest prefix match table, wherein the second table is an exact match table.

14. A method in a network device for compressing routing information, the method comprising the network device:
receiving a target prefix associated with a route in a routing table;
when the target prefix is less than a predetermined length, then programming the route in a first hardware table;
when the target prefix is greater than or equal to the predetermined length, then:
identifying a parent prefix of the target prefix;
generating children prefixes from the parent prefix;
generating a table entry to be written to a second hardware table;
storing the parent prefix into a first portion of the generated table entry;
for each child prefix among the children prefixes:
when the child prefix corresponds to a route in the routing table, then storing a next hop associated with the route into a location in a second portion of the generated table entry that is determined based on the child prefix; and
when the child prefix does not correspond to a route in the routing table, then storing a predefined value into the location in the generated table entry that does not represent a next hop; and
storing the generated table entry in the second hardware table,
wherein storage in the first hardware table is conserved by virtue of representing the routes that correspond to the children prefixes in one entry in the second hardware table and not storing the corresponding routes in individual entries in the first hardware table.

15. The method of claim 14, further comprising repeating the operations for additional target prefixes received from the routing table.

16. The method of claim 14, wherein the predefined value is used instead of a next hop associated with the parent prefix route when the child prefix is not associated with a route in the routing table.

17. The method of claim 14, wherein the received target prefix is associated with a /24 route or a /23 route or a /22 route in the routing table, wherein one or more of the children prefixes represent /24 routes in the routing table, wherein the parent prefix has length 21.

18. The method of claim 14, wherein the location in the table entry for the compressed routes table is determined based on the last N bits of the child prefix.

19. The method of claim 14, wherein the first hardware table is a longest prefix match hardware (LPM) table and the second hardware table is an exact match (EM) table.

20. The method of claim 14, further comprising using the first and second hardware tables to forward a received packet, including searching the first and second hardware tables using the received packet to determine a next hop for the received packet, wherein when the predefined value is encountered in a search result from the second hardware table instead of a next hop, then determining the next hop for the received packet using a search result from the first hardware table.
